(19) United States
(12) Patent Application Publication
(10) Pub. No.: US 2020/0241739 A1
(43) Pub. Date: Jul. 30, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Katsutoshi SAKAGUCHI, Kanagawa (JP)

(73) Assignee: FUJI XEROX CO., LTD., Tokyo (JP)

(21) Appl. No.: 16/511,371

(22) Filed: Jul. 15, 2019

(30) Foreign Application Priority Data
Jan. 25, 2019 (JP) 2019-011315

(51) Int. Cl. G06F 3/0488; G06F 3/0482; H04N 1/00

(52) U.S. Cl. CPC G06F 3/04883; G06F 3/0482; H04N 2201/0094; H04N 1/00925; H04N 1/00411

(57) ABSTRACT

An information processing apparatus includes a touch panel and a display that displays a list of abortable operations on the information processing apparatus in response to detection of a predetermined gesture performed in contact with the touch panel, the predetermined gesture being a movement that involves a change in point of contact with the touch panel.

### CROSS-REFERENCE TO RELATED APPLICATIONS

This application is based on and claims priority under 35 USC 119 from Japanese Patent Application No. 2019-011315 filed Jan. 25, 2019.

### BACKGROUND

### (i) Technical Field

The present disclosure relates to an information processing apparatus and a non-transitory computer readable medium.

### (ii) Related Art

Japanese Unexamined Patent Application Publication No. 2018-56647 discloses an image forming apparatus that, not in response to an operation instruction from a user but automatically, popup-displays on a touch panel a piece of information identifying a job in an execution-standby state and a button used to abort the execution of the job.

### SUMMARY

Touch panels replacing physical keys (hard keys) are currently widely used as an operation screen. A button to display a list of operations that are abortable on a host apparatus may not be arranged. If the list is displayed independently of an operation performed by a user, a portion that has been previously displayed may be hidden even though the user intends to display that portion. This presents difficulty for the user to verify the hidden portion or to operate the host apparatus.

Aspects of non-limiting embodiments of the present disclosure relate to enabling the user to perform a move operation to display a list of operations abortable on a host apparatus in a manner free from hiding information on a screen.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus. The information processing apparatus includes a touch panel and a display that displays a list of abortable operations on the information processing apparatus in response to detection of a predetermined gesture performed in contact with the touch panel, the predetermined gesture being a movement that involves a change in point of contact with the touch panel.

### BRIEF DESCRIPTION OF THE DRAWINGS

Exemplary embodiment of the present disclosure will be described in detail based on the following figures, wherein:

FIG. 1 illustrates the whole configuration of an image processing system of an exemplary embodiment;

FIG. 2 illustrates the hardware configuration of the image processing apparatus of the exemplary embodiment;

FIG. 3 illustrates the functional configuration of the image processing apparatus of the exemplary embodiment;

FIG. 4 illustrates an example of coordinates on a display;

FIG. 5 illustrates an example of a slant operation of a slant gesture;

FIGS. 6A and 6B are flowcharts illustrating an example of a determination process of the slant gesture;

FIG. 7 is a flowchart illustrating an example of the determination process of the slant gesture;

FIG. 8 is a flowchart illustrating an example of an aborting process of an abortable job;

FIGS. 9A through 9C illustrate specific operations to abort an abortable job by displaying a job list screen;

FIGS. 10A through 10C illustrate multiple types of the slant gesture:

FIGS. 11A and 11B illustrate another example of user operation to display the job list screen; and

FIG. 12 illustrates the hardware configuration of a computer to which the exemplary embodiment is applied.

### DETAILED DESCRIPTION

Embodiment of the disclosure is described in detail with reference to the attached drawings.

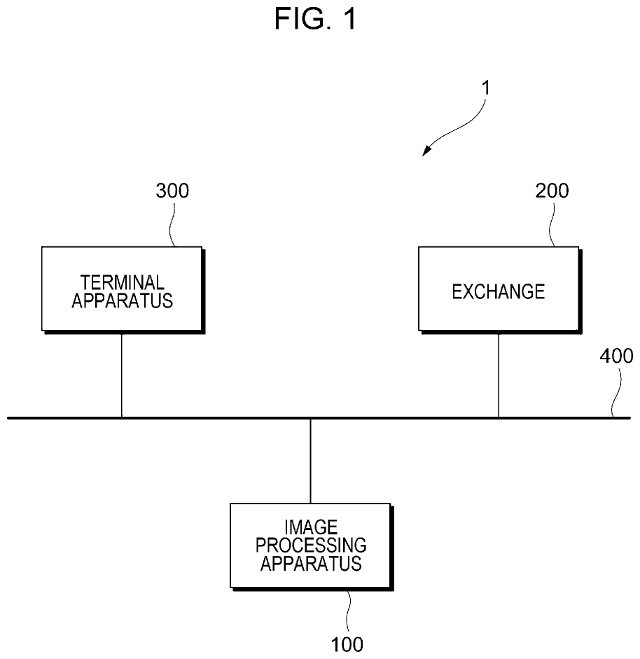

FIG. 1 illustrates the whole configuration of an image processing system 1 of the exemplary embodiment. As illustrated in FIG. 1, the image processing system 1 includes an image processing apparatus 100, an exchange 200, and a terminal apparatus 300. The image processing apparatus 100, the exchange 200, and the terminal apparatus 300 are connected to a network 400.

The image processing apparatus 100 has image processing functions including a print function, a scan function, a copy function and a facsimile (hereinafter referred to as fax) function. The image processing apparatus 100 thus performs an image processing process. The image processing apparatus 100 also performs printing by forming an image on a paper sheet in accordance with a print job. The image processing apparatus 100 receives image data via the fax function and prints an image in accordance with the received image data or transmits the image data to the exchange 200.

According to the exemplary embodiment, the image processing apparatus 100 is used as an example of an information processing apparatus.

The print job includes the image data serving as a print target and a control command in which a setting for a print operation is described. The print job is data serving as a unit of an operation for the print function (print operation) performed by the image processing apparatus 100. The data serving as a unit of the operation for a function other than the print function may be a scan job, a copy job, or a fax job. These jobs may be performed in accordance with a predetermined sequence of order and a job not in progress is in an execution-standby state. The image processing apparatus 100 may be interrupted to perform a job in a predetermined sequence of order or may perform multiple jobs in parallel.

The exchange 200 transmits or receives the image data via a telephone network via the fax function. The exchange 200 receives the image data from the image processing apparatus 100 or transmits the received image data to a destination of the fax function. The exchange 200 receives the image data addressed to the image processing apparatus 100 from another apparatus (not illustrated) or transmits the received image data to the image processing apparatus 100.

The terminal apparatus 300 is a computer that receives information from or transmits information to the image processing apparatus 100. For example, the terminal apparatus 300 transmits a print job to the image processing apparatus 100 or acquires a progress status of each job from the image processing apparatus 100. The terminal apparatus 300 may be a portable information terminal, such as a smart phone or a mobile phone, or a personal computer (PC).

The network 400 serves as a communication medium to be used by each of the image processing apparatus 100, the exchange 200, and the terminal apparatus 300 for information communication. The network 400 may be the Internet, a public telephone network, and/or a local-area network (LAN).

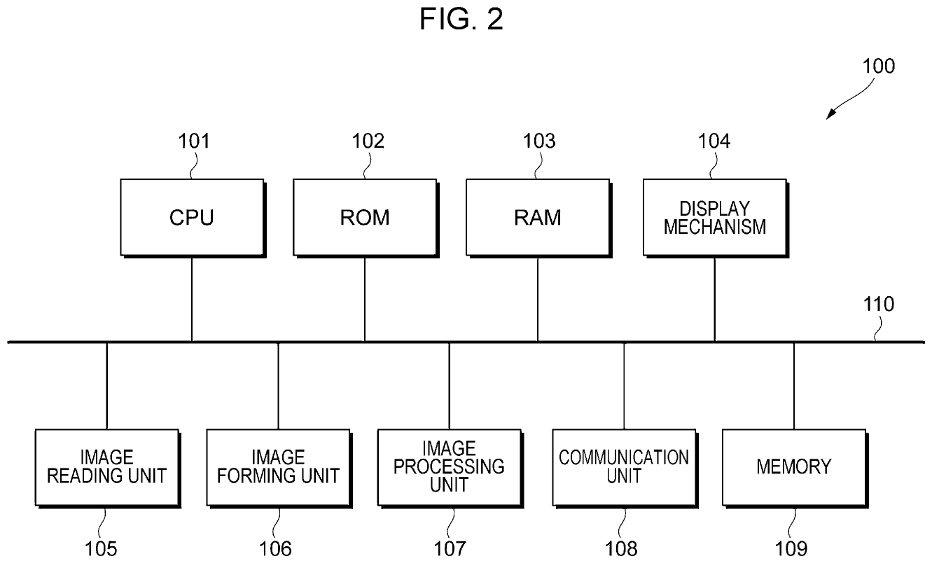

FIG. 2 illustrates the hardware configuration of an image processing apparatus 100 of the exemplary embodiment. The image processing apparatus 100 includes a central processing unit (CPU) 101, read-only memory (ROM) 102, random-access memory (RAM) 103, display mechanism 104, image reading unit 105, image forming unit 106, image processing unit 107, communication unit 108, and memory 109. These elements are connected to a bus 110 and exchange data via the bus 110.

The CPU 101 executes a variety of programs. The ROM 102 stores a control program to be executed by the CPU 101. The CPU 101 reads the control program from the ROM 102 and executes the read control program by using the RAM 103 as a working area. When the CPU 101 executes the control program, a variety of functions are performed by the image processing apparatus 100. In this way, a predetermined display is presented on the display mechanism 104. In addition, an image is formed on a paper sheet or an original document set on the image reading unit 105 is read.

The display mechanism 104 displays a variety of information while receiving an operation performed by a user. The display mechanism 104 includes a display panel, such as a liquid-crystal display, a touch panel mounted on the display panel and detecting a touch made by the user, a physical key pressed by the user, and the like. The display mechanism 104 displays a variety of screens on the display panel and receives an operation performed on the touch panel and the physical key by the user.

An element used to detect a touch includes but is not limited to an element detecting pressure responsive to the touch or an element detecting static electricity of an object touching the touch panel.

In the discussion that follows, the operation in which a finger of the user touches the touch panel is referred to as a touch operation. The touch operation is not limited to the user finger touching the touch panel. For example, the touch operation may be performed by the user who touches the touch panel with a stylus pen.

In accordance with the exemplary embodiment, because of mounting location restrictions of the display mechanism 104, the display mechanism 104 desirably includes no physical keys. For this reason, the image processing apparatus 100 does not include a physical key to display a list of jobs abortable (hereinafter referred to as abortable jobs) on the image processing apparatus 100 and a physical key to abort the abortable job. Because of mounting location restrictions of the display mechanism 104, the display panel of the display mechanism 104 is designed to fit into a predetermined size.

The abortable job is a job that the user is able to abort on the image processing apparatus 100. In other words, the abortable job is a job that is unfinished on the image processing apparatus 100. Specifically, the abortable jobs may be a job currently in progress on the image processing apparatus 100, a job waiting on standby (an execution-standby job), and a job in error.

The image reading unit 105 reads an original document and generates the image data representing the image of the read original document. For example, the image reading unit 105 is a scanner. The image reading unit 105 may be a charge-coupled device (CCD) system or a contact image sensor (CIS) system. In the CCD system, a light source radiates a light beam to the original document, a light beam is reflected from the original document, and a CCD receives the reflected light beam via a lens in a contracted form. In the CIS system, a CIS receives a light beam reflected from the original document when the original document is irradiated with a light beam by a light emitting diode (LED).

The image forming unit 106 includes a print mechanism that forms an image on a recording medium, such as a paper sheet. For example, the image forming unit 106 is a printer. The image forming unit 106 uses an electrophotographic system or an ink-jet system. The electrophotographic system forms an image on the recording medium by transferring a toner image on a photoconductor drum to the recording medium. The ink-jet system forms an image on the recording medium by ejecting ink onto the recording medium.

The image processing unit 107 performs image processing on input image data, such as color correction and/or gradation correction. The image processing unit 107 thus generates the image data that has undergone the image processing and then outputs the resulting image data to the image forming unit 106.

The communication unit 108 is connected to a communication network (not illustrated) and functions as a communication interface that performs communication with another apparatus connected to the communication network. For example, if the fax function is performed, the image data obtained when the image reading unit 105 reads the original document is transmitted to another apparatus via the communication unit 108.

The memory 109 includes a memory region, such as a hard disk drive (HDD), and stores data received by the communication unit 108 and/or data generated by the image processing apparatus 100.

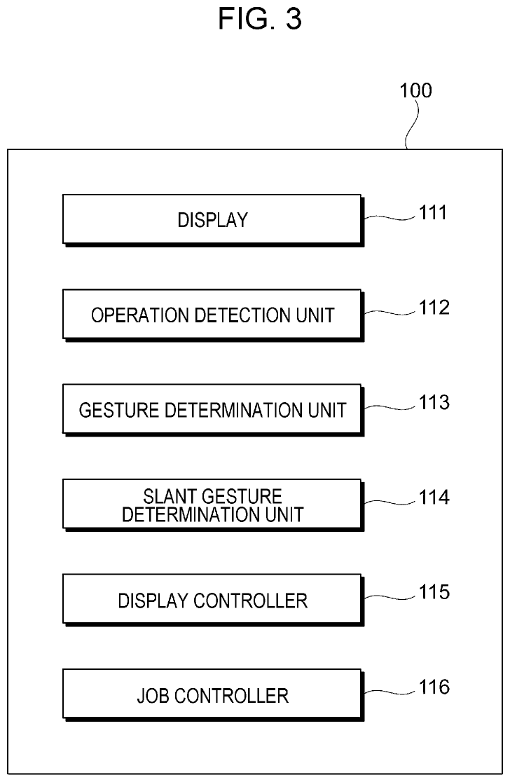

The functional configuration of the image processing apparatus 100 of the exemplary embodiment is described below. FIG. 3 is a block diagram illustrating the functional configuration of the image processing apparatus 100 of the exemplary embodiment. The image processing apparatus 100 of the exemplary embodiment includes a display 111, operation detection unit 112, gesture determination unit 113, slant gesture determination unit 114, display controller 115, and job controller 116.

The display 111 is a display panel of the display mechanism 104 and displays a variety of screens in response to a control signal output from the display controller 115.

The display 111 displays a home screen displaying a variety of icons indicating the functions enabled on the image processing apparatus 100 and a detail setting screen to make a detail setting for the functions of the image processing apparatus 100 (for example, a detail setting screen used to make a detail setting of a print function). The display 111 displays a screen of a list of abortable jobs of the image processing apparatus 100 (hereinafter referred to as a job list screen).

The operation detection unit 112 detects a touch operation performed on the display 111 by the user and outputs information on the detected touch operation to the gesture determination unit 113.

When a finger of the user touches the display 111, the operation detection unit 112 detects coordinates of a touched point in a rectangular coordinate system of the display 111 and outputs the coordinates to the gesture determination unit 113. In this case, while the touch operation is performed, the operation detection unit 112 outputs to the gesture determination unit 113 information indicating that the touch operation is currently being performed, location information on the touch location (coordinate information, hereinafter referred to as “touch location information”) on the display 111, and time information on the time when the touch operation is detected (hereinafter referred to as touch time information).

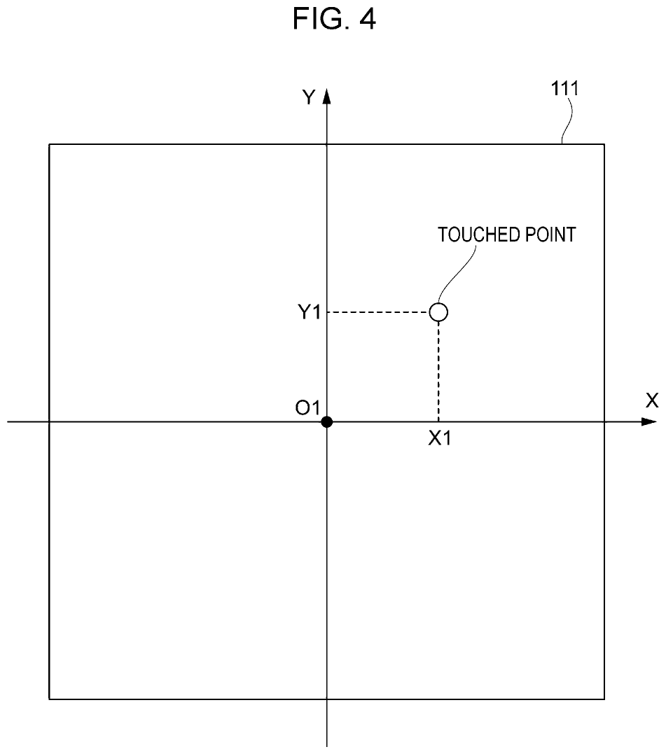

FIG. 4 illustrates an example of coordinates on the display 111. Referring to FIG. 4, the rectangular coordinate system is set up in the display 111. The origin O1(0,0) is set to be the center of the display 111, the X axis (the right portion of the X axis is positive) is set to be the horizontal direction of the display 111, and the Y axis (the upward portion of the Y axis is positive) is set to be the vertical direction of the display 111. With respect to the shape of the display 111, the horizontal line represents the X axis and the vertical line represents the Y axis. Each coordinate value is the number of pixels counted from the origin O1. When a finger of the user touches the display 111, the operation detection unit 112 detects X coordinate (X1) of the touched point and Y coordinate (Y1) of the touched point and outputs the coordinates (X1,Y1) to the gesture determination unit 113.

In accordance with the information received from the operation detection unit 112, the gesture determination unit 113 determines the type of the touch operation (namely, a gesture) detected by the operation detection unit 112.

Upon receiving the information indicating the operation of the touching finger with the display 111, the gesture determination unit 113 determines that the detected touch operation is a press operation. The gesture determination unit 113 notifies the slant gesture determination unit 114 of a touch event as a press operation.

Upon receiving the information indicating the operation of moving the touch location along the surface of the display 111, the gesture determination unit 113 determines that the detected touch operation is a move operation. The gesture determination unit 113 notifies the slant gesture determination unit 114 of a touch event as move.

Upon receiving the information indicating the operation of a finger liftoff from the display 111, the gesture determination unit 113 determines that the detected touch operation is a “release” operation. The gesture determination unit 113 notifies the slant gesture determination unit 114 of a touch event as the release operation.

In accordance with the touch event notified by the gesture determination unit 113, the slant gesture determination unit 114 determines whether a predetermined operation of the user to move slantly the touch location (hereinafter referred to as a “slant gesture”) has been performed.

When notified of the touch event of the move or release operation, the slant gesture determination unit 114 determines whether the trajectory of the touch location is slant and determines whether the travel distance per unit time is in excess of a predetermined distance. If the trajectory of the touch location is slant and the travel distance per unit time within a time period from the start of the movement taking a slant trajectory to the end of the movement is in excess of the predetermined distance, the slant gesture determination unit 114 determines that the slant gesture has been made. In accordance with the exemplary embodiment, an example of the predetermined move operation is a slant gesture.

The slant gesture is aligned with a direction inclined with respect to the predetermined horizontal direction and vertical direction on the display 111. In the rectangular coordinate system of the display 111, the slant gesture is performed in a direction inclined with respect to the X and Y axes. The horizontal direction of the shape of the display 111 is designated with the X axis and the vertical direction of the shape of the display 111 is designated with the Y axis of the shape of the display 111.

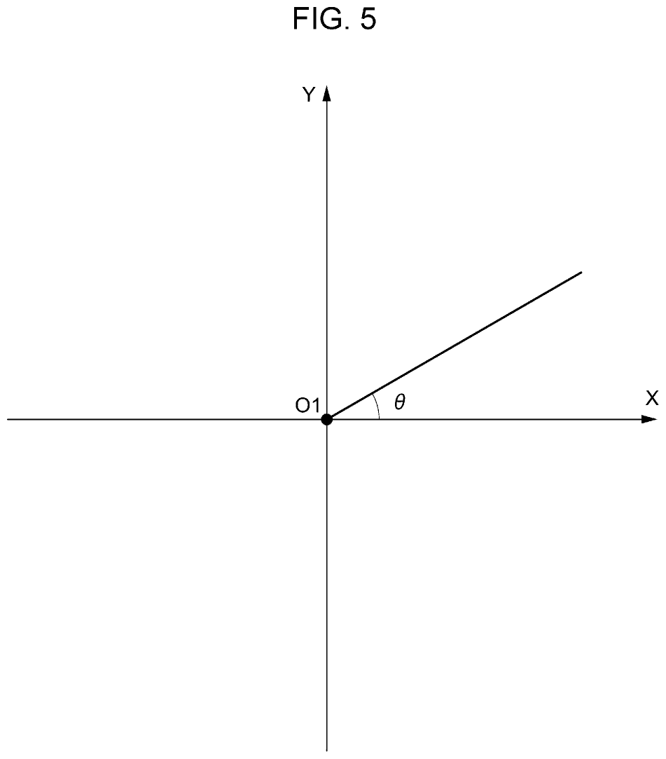

FIG. 5 illustrates an example of the slant gesture. Let θ represent the slant angle with respect to the positive direction of the X axis and the positive direction of the X axis is θ=0 and the positive direction of the Y axis is θ=90 degrees. The slant direction falls within each of the following ranges: 0°<θ<90°, 90°<θ<180°, 180°<θ<270°, and 270°<θ.

A predetermined angle range may be set with respect to θ=45°. For example, an angle range of ±15° with respect to 45° may be set to be a range of slant direction θ. Alternatively, θ falling with the range of 20°<θ<70° may be set to be the range of slant direction θ.

The display controller 115 serving as a display generates a control signal controlling the display 111 in a displaying operation thereof. The display controller 115 thus controls the display 111 in the displaying operation thereof. If the slant gesture determination unit 114 determines that a slant gesture has been performed, the display controller 115 displays a job list screen on the display 111.

The job controller 116 controls the process of each job performed on the image processing apparatus 100. For example, if an abortable job is selected on the job list screen via a user operation, the job controller 116 performs control to abort the selected abortable job.

Specifically, if the abortable job selected on the job list screen is in progress, the job controller 116 performs control to abort the execution of the job. If the job in progress is a print job, the job controller 116 instructs the image forming unit 106 to abort the print process.

If the abortable job selected on the job list screen is in an execution-standby state, the job controller 116 discontinues the execution-standby state of the job and performs control such that the job is not executed or discontinues the execution-standby state until a further instruction from the user.

The user may update the setting of the aborted job or re-execute the job again after being aborted. The job controller 116 may also delete the aborted job.

The abortable job selected on the job list screen means that a tap operation has been performed on an image indicating the abortable job on the job list screen. The tap operation is accomplished when a “press” operation is performed and followed by a “release” operation within a predetermined time period from the press operation rather than being followed by a “move” operation.

The elements of the image processing apparatus 100 may be implemented by using software and hardware together in cooperation. For example, if the image processing apparatus 100 is implemented using the hardware configuration in FIG. 2, a variety of programs stored on the ROM 102 and/or the memory 109 are read onto the RAM 103 and then executed by the CPU 101. In this way, the function blocks including the operation detection unit 112, the gesture determination unit 113, the slant gesture determination unit 114, the display controller 115, and the job controller 116 are implemented as illustrated in FIG. 3. The display 111 is implemented by using the display mechanism 104.

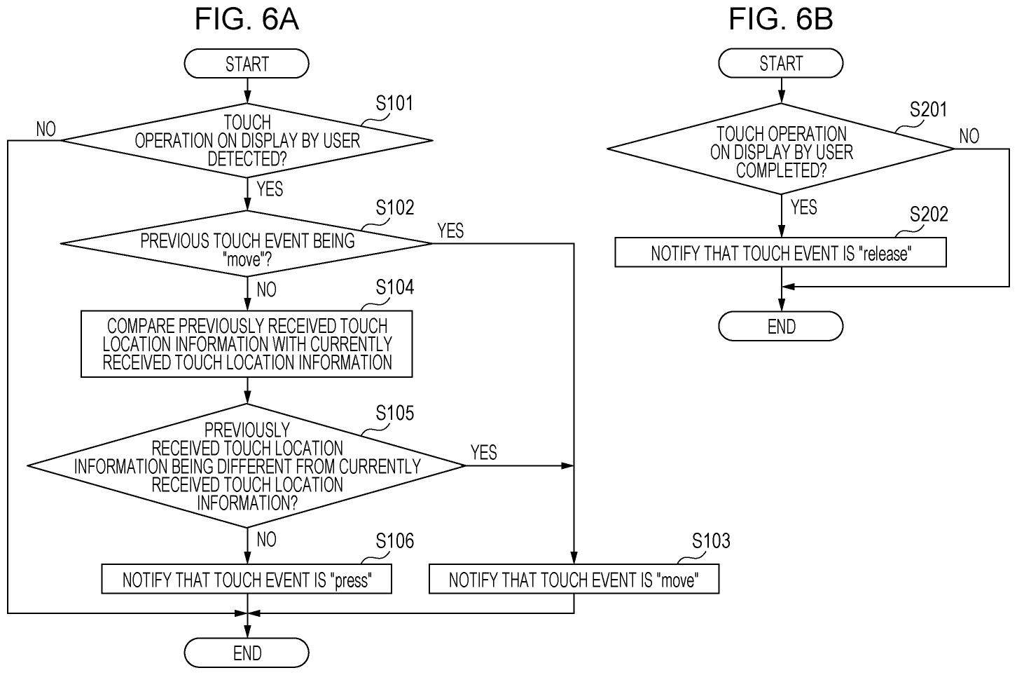

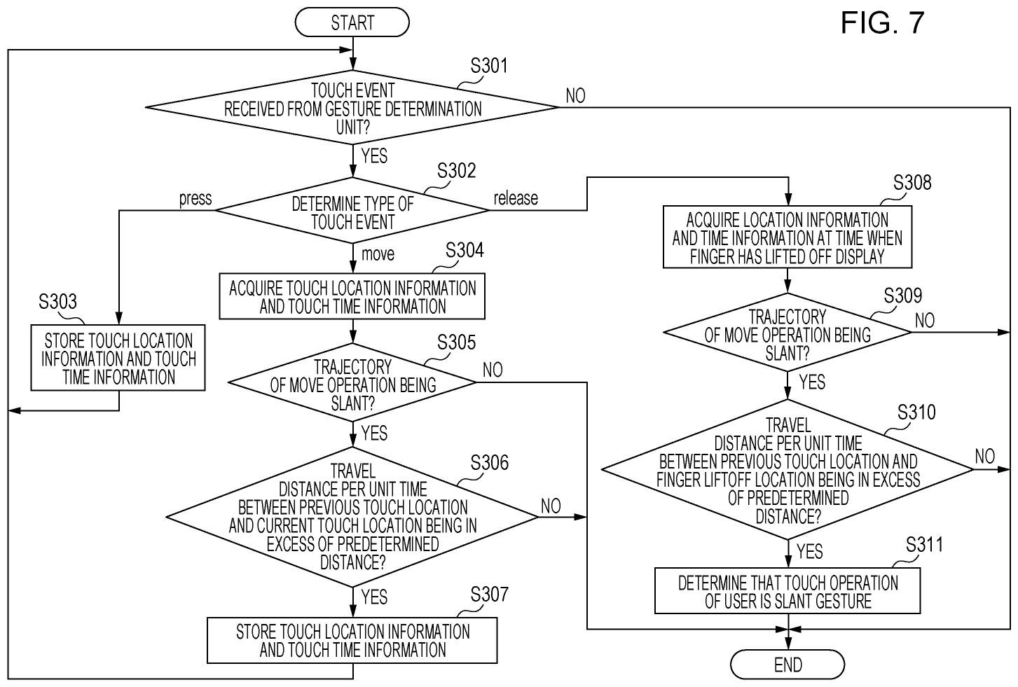

A gesture determination process as to whether the slant gesture has been performed is described below. FIGS. 6A and 6B and 7 are flowcharts illustrating the gesture determination process.

The processes illustrated in FIGS. 6A and 6B and 7 are performed in parallel with each other. The processes illustrated in FIGS. 6A and 6B and 7 may be performed periodically (for example, every 10 ms). In the discussion that follows, each step indicating a corresponding operation is denoted by “S”.

The flowchart in FIG. 6A is described first. The operation detection unit 112 determines whether the touch operation performed on the display 111 by the user has been detected (S101). If the result of the determination operation in S101 is no, the process ends. If the result of the determination operation in S101 is yes, the operation detection unit 112 outputs to the gesture determination unit 113 the information indicating that the touch operation has been detected, the location information of the touch location on the display 111 (the touch location information), and the time information when the touch operation has been detected (the touch time information).

The gesture determination unit 113 determines whether the previous touch event is a move operation (S102). In this case, the gesture determination unit 113 determines whether the type of the touch operation determined by the gesture determination unit 113 after the start of the touch operation by the user is the move operation.

If the result of the determination operation in S102 is yes, the gesture determination unit 113 determines that the touch operation for move continues on the display 111 and then notifies the slant gesture determination unit 114 that the touch event is the move operation (S103). In this case, the gesture determination unit 113 also outputs to the slant gesture determination unit 114 the information acquired from the operation detection unit 112, namely, the touch location information and the touch time information. The process thus ends.

If the result of the determination operation in S102 is no, the gesture determination unit 113 compares the touch location information received from the operation detection unit 112 after the start of the touch operation by the user with the touch location information newly received from the operation detection unit 112 (S104). In accordance with on the comparison results, the gesture determination unit 113 determines whether the previous touch location information is different from the current touch location information (S105).

If the result of the determination operation in S105 is yes, the gesture determination unit 113 determines that the touch operation for move has been performed on the display 111 and proceeds to S103.

If the result of the determination operation in S105 is no, the gesture determination unit 113 determines that the touch operation for press has been performed on the display 111 and notifies the slant gesture determination unit 114 of the touch event for the press operation (S106). In this case, the gesture determination unit 113 outputs to the slant gesture determination unit 114 the information acquired from the operation detection unit 112, namely, the touch location information and the touch time information. The process thus ends.

If no previous touch location information is available in S104, the result of the determination operation in S105 is no and the process proceeds to S106.

The flowchart in FIG. 6B is now described. The operation detection unit 112 determines whether the user has ended the touch operation on the display 111 (S201). If a finger of the user lifts off the display 111, the result of the determination operation in S201 is yes. If the result of the determination operation in S201 is yes, the operation detection unit 112 outputs to the gesture determination unit 113 the information indicating that the touch operation has been ended, the touch location information (the location information indicating the location at which the finger has lifted off the display 111), and the touch time information (the time information when the finger has lifted off the display 111).

If the result of the determination operation in S201 is yes, the gesture determination unit 113 determines that the touch operation for release has been performed on the display 111. The gesture determination unit 113 notifies the slant gesture determination unit 114 of the touch event for gesture (S202). The gesture determination unit 113 also outputs to the slant gesture determination unit 114 the information acquired from the operation detection unit 112, namely, the touch location information and the touch time information. The process thus ends.

If the result of the determination operation in S201 is no, the process ends. In such a case, the operation detection unit 112 had detected the touch operation on the display 111 and the result of the determination operation in S101 in FIG. 6A is yes.

The flowchart in FIG. 7 is described. The slant gesture determination unit 114 determines whether the gesture determination unit 113 has notified the touch event to the slant gesture determination unit 114 (S301). If the result of the determination operation in S301 is no, the process ends.

If the result of the determination operation in S301 is yes, the slant gesture determination unit 114 determines the type of the touch event notified by the gesture determination unit 113 (S302). The slant gesture determination unit 114 determines the touch event as to whether the touch event is the press, move, or release operation.

If the touch event is determined to be the press operation in S302, the slant gesture determination unit 114 acquires and stores the touch location information and the touch time information (S303). The process returns to S301 and the determination is repeated about the touch event.

If the touch event is determined to be a move operation in S302, the slant gesture determination unit 114 acquires the touch location information and touch time information (S304). The slant gesture determination unit 114 compares the touch location information previously received and stored after the start of the touch operation by the user with the newly received touch location information. In accordance with the two pieces of the touch location information, the slant gesture determination unit 114 determines whether the trajectory of the move operation is slant (S305). For example, the slant gesture determination unit 114 computes an angle of the trajectory of the move operation from the two pieces of touch location information and determines whether the trajectory of the move operation is slant or not.

In the move operation of the user, the angle of the trajectory of the move operation may vary if the user changes the travel direction of the finger. In S305, the slant gesture determination unit 114 determines whether the trajectory of the move operation is slant by comparing angles computed after the start of the touch operation of the user. Specifically, if a difference between a minimum one and a maximum one of the angles computed after the start of the touch operation of the user falls within a predetermined range (for example, 10° or less), the trajectory of the move operation is determined to be slant. On the other hand, if the difference is in excess of the predetermined range, the trajectory of the move operation is determined not to be slant.

If the result of the determination operation in S305 is no, the process ends. In such a case, the touch operation of the user is determined not to be the slant gesture.

On the other hand, if the result of the determination operation in S305 is yes, the slant gesture determination unit 114 compares the touch location information and touch time information previously received and stored after the start of the touch operation by the user with the newly received touch location information and touch time information. In accordance with the previous touch location information and the current touch location information, the slant gesture determination unit 114 determines whether the travel distance per unit time is in excess of a predetermined distance (S306).

If the result of the determination operation in S306 is no, the process ends. In such a case, the touch operation of the user is determined not be the slant gesture.

If the result of the determination operation in S306 is yes, the slant gesture determination unit 114 stores the newly acquired touch location information and touch time information (S307). The process returns to S301 and the determination operation is repeated about the touch event.

If the touch event is determined to be a release operation in S302, the slant gesture determination unit 114 acquires the location information and time information obtained when the finger has lifted off the display 111 (S308). The slant gesture determination unit 114 compares the touch location information previously acquired and stored after the start of the touch operation of the user with the newly acquired location information. The slant gesture determination unit 114 determines whether the trajectory of the move operation determined from the two pieces of location information is slant (S309). The operation in S309 is identical to the operation in S305.

If the result of the determination operation in S309 is no, the process ends. In such a case, the touch operation of the user is determined not to be the slant gesture.

If the result of the determination operation in S309 is yes, The slant gesture determination unit 114 compares the touch location information and touch time information previously acquired and stored after the start of the touch operation of the user with the newly acquired touch location information and touch time information. The slant gesture determination unit 114 determines whether the travel distance per unit time between the previous touch location and the location at which the finger has lifted off is in excess of a predetermined distance (S310).

If the result of the determination operation in S310 is no, the process ends. In such a case, the touch operation of the user is determined not to be the slant gesture.

If the result of the determination operation in S310 is yes, the slant gesture determination unit 114 determines that the touch operation of the user is the slant gesture (S311). The process thus ends.

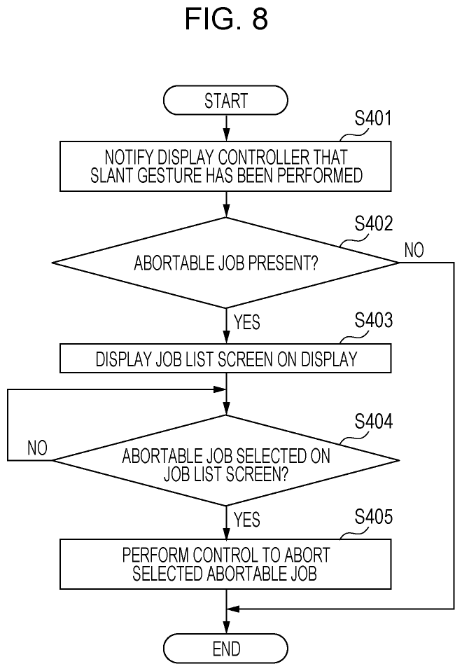

The aborting process of an abortable operation is described. FIG. 8 is a flowchart illustrating an example of the aborting process of the abortable operation. In the discussion that follows, each step indicating a corresponding operation is denoted by “S”.

If the slant gesture determination unit 114 determines in S311 in FIG. 7 that the slant gesture has been performed, the slant gesture determination unit 114 notifies the display controller 115 that the slant gesture has been performed (S401). The display controller 115 determines whether an abortable job is present on the image processing apparatus 100 (S402). If the result of the determination operation in S402 is no, the process ends. On the other hand, if the result of the determination operation in S402 is yes, the display controller 115 displays the job list screen on the display 111 (S403).

The job controller 116 determines whether an abortable operation is selected on the job list screen (S404). If the result of the determination operation in S404 is yes, the job controller 116 performs control to abort the selected abortable job (S405). The process thus ends.

If the user touches outside the job list screen on the display 111 in S404 or the abortable job remains unselected on the job list screen for a predetermined period of time in S404, the process may also end.

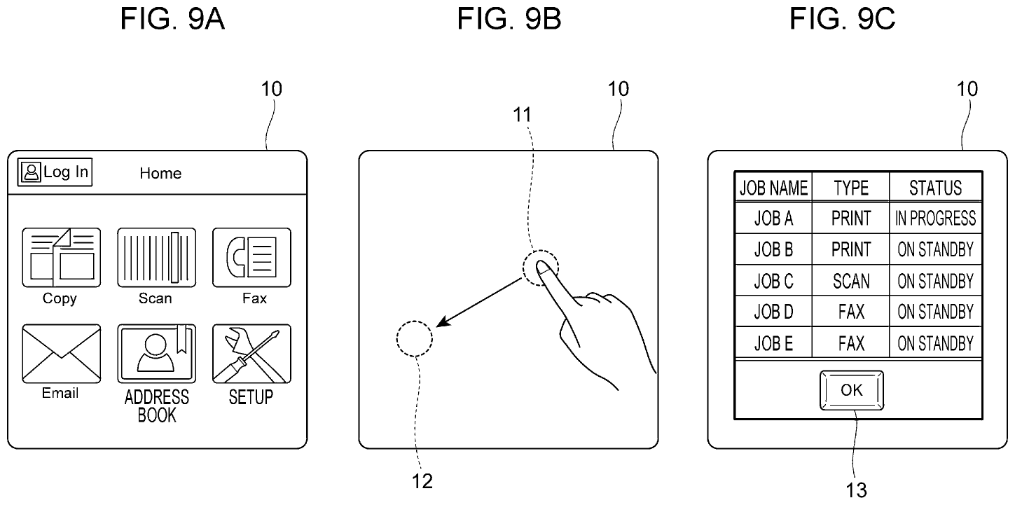

The process of aborting an abortable job with the job list screen displayed is specifically described. FIGS. 9A through 9C illustrate the aborting process to abort an abortable job with the job list screen displayed.

FIG. 9A illustrates a home screen 10. The user selects a function of the image processing apparatus 100 by selecting an icon displayed on the home screen 10. The home screen 10 does not include a button that receives an instruction to display a list of abortable jobs and a button that receives an instruction to abort an abortable job.

Referring to FIG. 9B, the user may now touch a region 11 with their finger, move the touch location in a direction denoted by an arrow mark (namely, in a direction looking to the bottom right corner of the region 11), and lift their finger off a region 12. The move operation is performed in a slant direction. If the travel distance per unit time through a time period between the start of the move operation of the user and the end of the move operation, namely a time period for the touch location moving from the region 11 to the region 12 is in excess of a predetermined distance, the slant gesture determination unit 114 determines that the slant gesture has been performed. The slant gesture determination unit 114 notifies the display controller 115 that the slant gesture has been performed.

Referring to FIG. 9C, the display controller 115 displays the job list screen. In FIG. 9C, jobs A through E are listed as abortable jobs. The jobs A and B are print jobs, the job C is a scan job, and the jobs D and E are fax jobs. The printing of the job A is currently in progress on the image processing apparatus 100 and the jobs B through E are in the execution-standby state.

The user may now point to the job A and press an OK button 13. The job controller 116 instructs the image forming unit 106 to abort the job A. If the user points to the job D and presses the OK button 13, the job controller 116 performs control such that the image data generated in accordance with the job D is not transmitted to the exchange 200.

The job controller 116 may be designed to select multiple abortable jobs on the job list screen. For example, if the user points to the jobs D and E and presses the OK button 13, the job controller 116 performs control such that the jobs D and E are aborted.

The OK button 13 may not necessarily be arranged on the job list screen. In accordance with the user pointing to an abortable job, the job controller 116 may abort the pointed abortable job. In such a case, each time the user points to an abortable job, the abortable job is aborted.

The job list screen may be without the OK button 13. The display controller 115 may display a screen that asks for the user permission to abort the pointed abortable job. For example, if the user presses the OK button 13 on the newly displayed screen, the abortable job is aborted.

All abortable jobs present on the image processing apparatus 100 may be displayed on the job list screen or abortable jobs only for the user may be displayed.

The user is authenticated by entering a user ID or a password on the display 111 or by holding an integrated card (IC) card, such as an employment pass, over an IC card reader of the image processing apparatus 100. The successful authentication of the user leads to a login state in which the user has logged in. If the user performs the slant gesture, the display controller 115 identifies the abortable job generated in accordance with the operation performed by the user having logged in, from among the abortable jobs present on the image processing apparatus 100. The job list screen having a list of identified abortable jobs is thus displayed.

If the administrator of the image processing apparatus 100 has logged in, the display controller 115 displays all the abortable jobs present on the image processing apparatus 100. If the user is not authenticated (specifically, if no user has logged in), all the abortable jobs present on the image processing apparatus 100 may be displayed or only the abortable jobs generated with no user authentication performed may be displayed.

A process of switching between slant gestures to display the job list screen is described below. In accordance with the exemplary embodiment, multiple types of slant gestures are defined in advance and switching between move operations using a slant gesture is performed under a predetermined condition. The slant gesture determination unit 114 serves as a switch unit.

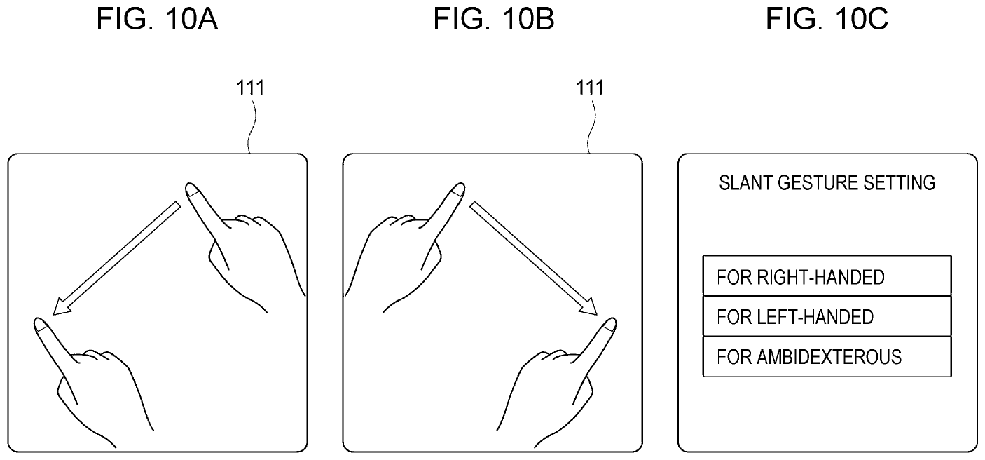

The slant gesture determination unit 114 switches between slant gestures to display the job list screen in accordance with the setting of the image processing apparatus 100. FIGS. 10A through 10C illustrate the multiple types of slant gestures.

FIG. 10A illustrates the slant gesture of a right-handed user. Specifically, the slant gesture is a move operation that is a movement of the finger in the top right to bottom left direction on the display 111. The move operations of the slant gesture may include four movement patterns, a pattern in the top right to bottom left direction, another pattern in the bottom left to top right direction, another pattern in the top left to bottom right direction, and another pattern in the bottom right to top left direction. If the user is right-handed, the pattern in the top right to bottom left direction is considered to be the easiest pattern. The move operation in the top right to bottom left direction on the display 111 is thus set to be the slant gesture for the right-handed user.

FIG. 10B illustrates the slant gesture of a left-handed user. Specifically, FIG. 10B illustrates a move operation performed in the top left to bottom right direction on the display 111. If the user is left-handed, the pattern in the top left to bottom right direction is considered to be the easiest. The move operation of the pattern in the top left to bottom right direction on the display 111 is set to be the slant gesture of the left-handed user.

FIG. 10C illustrates an example of a screen used to set the slant gesture. The screen lists right-handed, left-handed, and ambidextrous users. If the right-handed user is selected, the move operation in the top right to bottom left direction on the display 111 is set to be the slant gesture. When the user moves their finger in the top right to bottom left direction and if the travel distance per unit time is in excess of a predetermined distance, the slant gesture determination unit 114 determines that the slant gesture has been performed. The job list screen is thus displayed.

If the left-hand user is selected, the move operation in the top left to bottom right direction on the display 111 is set to be the slant gesture. If the ambidextrous user is selected, the right-handed setting and the left-handed setting are performed. Specifically, the move operation in the top right to bottom left direction on the display 111 and the move operation in the top left to bottom right direction on the display 111 are set to be the slant gestures. In this way, the slant gesture determination unit 114 switches between the move operations to be used as the slant gesture in accordance with the setting of the image processing apparatus 100.

The slant gesture determination unit 114 may switch the move operations to be used as the slant gesture in accordance with the user performing the gesture.

For example, each user who operates the image processing apparatus 100 may be registered beforehand as being right-handed or left-handed. The slant gesture determination unit 114 determines whether the login user is right-handed or left-handed. The slant gesture determination unit 114 switches between the move operations to be used as the slant gesture in accordance with the determination results. If the user is not registered as being right-handed or left-handed, a default setting (for example, right-handed setting) is used. The user themselves may register which of the right-handed, the left-handed, and the ambidextrous settings is to be used.

The right-handed slant gesture and the left-handed slant gesture are not limited to those described above. Not only the move operation performed in the top right to bottom left direction on the display 111 but also the move operation performed in the bottom left to top right direction on the display 111 may be set to be the right-handed slant gesture.

The move operation that the user may register as the slant gesture is not limited to the right-handed, the left-handed, and the ambidextrous settings. For example, the user may register the move operation in the top right to bottom left direction on the display 111 and the move operation in the top left to bottom right direction on the display 111 as the slant gestures.

In the example described above, the slant gesture determination unit 114 determines that the slant gesture has been performed if the trajectory of the touch location is slant and if the travel distance per unit time between the start of the touch operation to draw a slant trajectory and the end of the trajectory is in excess of a predetermined distance. The determination process of the slant gesture is not limited to this procedure.

For example, without determining whether the travel distance per unit time is in excess of the predetermined distance, the slant gesture determination unit 114 determines the slant gesture in accordance with whether the trajectory of the touch location is slant.

If the trajectory of the touch location is slant and if the time period between the start of the touch operation to draw a slant trajectory and the end of the trajectory is within a predetermined time period, the slant gesture determination unit 114 may determine that the slant gesture has been performed.

Furthermore, if the trajectory of the touch location is slant and if the travel distance between the start of the touch operation to draw a slant trajectory and the end of the trajectory is in excess of a predetermined distance, the slant gesture determination unit 114 may determine that the slant gesture has been performed. Also, the time period and distance described above may be combined in the determination operation.

As described above, in accordance with the exemplary embodiment, the display controller 115 displays a list of abortable jobs on the image processing apparatus 100 if the slant gesture by the user has been detected. When the user selects one of the abortable jobs, the job controller 116 performs control to abort the selected abortable job.

The job list image is displayed when the slant gesture is performed by the user. In accordance with the exemplary embodiment, however, the operation of the user to display the job list screen is not limited to the slant gesture.

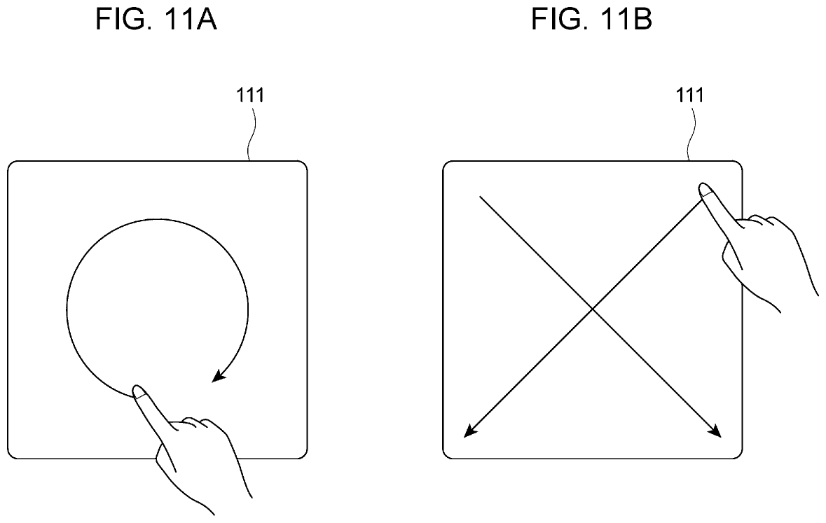

FIGS. 11A and 11B illustrate another example of user operation to display the job list screen. Referring to FIG. 11A, the move operation drawing a circle on the display 111 is an operation to display the job list screen. The circle is any rounded curved line. The trajectory of the move operation may be open and may not necessarily intersect. Referring to FIG. 11B, the move operation drawing two lines crossing each other on the display 111 is an operation to display the job list screen.

The move operation to draw a circle or two lines crossing each other may be an operation having a travel distance per unit time between the start of the move operation by the user to the end of the move operation being in excess of a predetermined distance. The move operation may have a travel distance between the start of the move operation by the user to the end of the move operation being equal to or below a predetermined distance. The move operation may have a travel distance between the start of the move operation by the user to the end of the move operation being in excess of a predetermined distance. The move operation may be performed in a combination of these conditions.

Each of the right-handed setting and the left-handed setting may be performed on the operations illustrated in FIGS. 11A and 11B. Referring to FIG. 11A, in the right-handed setting, the move operation of drawing clockwise the circle on the display 111 is an operation to display the job list screen. In the left-handed setting, the move operation of drawing counterclockwise the circle on the display 111 is an operation to display the job list screen.

Referring to 11B, in the right-handed setting, the move operation of drawing first the line in the top right to bottom left direction of the two lines crossing each other is an operation to display the job list screen. In the left-handed setting, the move operation of drawing first the line in the top left to bottom right direction of the two lines crossing each other is an operation to display the job list screen.

In the example described above, the job list screen is displayed when the slant gesture has been performed by the user. In accordance with the exemplary embodiment, however, the operation performed when the slant gesture is performed is not limited to the operation to display the job list screen.

In the exemplary embodiment, contents of the operation may be changed depending on the number of abortable operations. For example, when the slant gesture has been performed, the display controller 115 determines whether an abortable job is present on the image processing apparatus 100. If multiple abortable jobs are present, the display controller 115 displays the job list screen. The job controller 116 performs control to abort the abortable job selected on the job list screen by the user. If only one abortable job is present, the job controller 116 performs control to abort the abortable job in accordance with the execution of the slant gesture regardless of whether the abortable job is selected on the job list screen by the user. The display controller 115 may display a message telling that the abortable job has been aborted.

The above operation is not limited to the single abortable job. If the number of abortable jobs is equal to or below a predetermined number, the above operation may be performed. For example, the job controller 116 performs control to abort all the abortable jobs in accordance with the execution of the slant gesture regardless of whether the abortable jobs are selected on the job list screen by the user. The job controller 116 is an example of an aborting unit.

In accordance with the exemplary embodiment, the contents of the process may be modified depending on the type of abortable jobs. For example, if the slant gesture is performed and a predetermined operation is included in the abortable jog, the job controller 116 performs control to abort the abortable job in accordance with the execution of the slant gesture regardless of whether the abortable job is selected on the job list screen by the user.

Specifically, if the abortable job is a fax job, the job controller 116 performs control to abort the fax job as the abortable job in accordance with the execution of the slant gesture regardless of whether the fax job is selected on the job list screen by the user.

The display controller 115 displays the job list screen. The user may select the fax job on the job list screen and may cancel the abortion status of the selected abortable job. The fax job with the abortion status thereof canceled shifts back to be in an in-progress state or in an execution-standby state. If the user selects an abortable job other than the fax job, the display controller 115 performs control to abort the selected abortable job.

The fax job includes transmitting data, such as an image, from the image processing apparatus 100 to another apparatus. The fax job has an emergency abortion function in order not to erratically transmit data to another apparatus. The emergency abortion function may be triggered regardless of whether the emergency abortion function is selected by the user.

The emergency abortion function triggered by the slant gesture is not limited to the fax job. For example, a print job may be aborted in accordance with the execution of the slant gesture in order to control a waste of paper sheets caused by erratic printing.

The image processing apparatus 100 of the exemplary embodiment has been described. The exemplary embodiment may be applied to another apparatus including a touch panel, such as a portable information terminal (such as a smart phone or a tablet terminal) or a car navigation system. A computer 500 as a portable information terminal may be substituted for the image processing apparatus 100. The hardware configuration of the computer 500 is described below. The computer 500 is an example of an information processing apparatus.

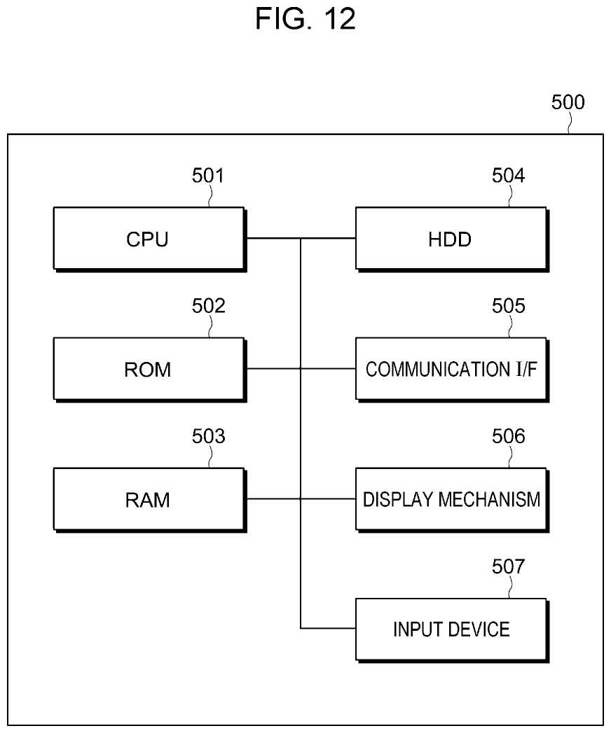

FIG. 12 illustrates the hardware configuration of the computer 500 of the exemplary embodiment. Referring to FIG. 12, the computer 500 includes a CPU 501 serving as an arithmetic unit, a ROM 502 serving as a memory region storing a program, such as a basic input output system (BIOS), and a RAM 503 serving as a memory region storing the program. The computer 500 further includes an HDD 504 serving as a memory region storing a variety of programs such an operating system (OS) and an application, data input to a variety of programs, and data output from the variety of programs. The program stored on the ROM 502 or HDD 504 is read onto the RAM 503 and then executed by the CPU 501. The functions of the computer 500 are thus executed.

The computer 500 further includes a communication interface (I/F) 505 used to communicate with an external device, a display mechanism 506, such as a display, and an input device 507 including a keyboard, a mouse, and/or a touch panel.

The abortable jobs of the image processing apparatus 100 include the print job and fax job as described above. The abortable job may be any job that may be aborted by the user. If the computer 500, such as the portable information terminal or the car navigation system, is used, a list of abortable jobs for the computer 500 is displayed.

In the above discussion, the image processing apparatus 100 does not include a physical key used to display a list of abortable jobs and a physical key used to abort an abortable job. Furthermore, the screen of the display mechanism 104 does not include a button used to display a list of abortable jobs and a button used to abort an abortable job. Even if these physical keys and buttons are arranged, the exemplary embodiment is still applicable.

The program implementing the exemplary embodiment of the disclosure may provided not only by using a communication medium but also by using a recording medium, such as a compact disk read-only memory (CD-ROM) having stored the program.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a touch panel; and
a display that displays a list of abortable operations on the information processing apparatus in response to detection of a predetermined gesture performed in contact with the touch panel, the predetermined gesture being a movement that involves a change in point of contact with the touch panel.

2. The information processing apparatus according to claim 1, further comprising:
a switch unit that switches, under a predetermined condition, the predetermined gesture to another predetermined gesture, the predetermined gesture being a movement that involves a change in point of contact with the touch panel.

3. The information processing apparatus according to claim 2, wherein the another predetermined gesture is determined in accordance with a user performing the predetermined gesture.

4. The information processing apparatus according to claim 3, wherein the another predetermined gesture is determined in accordance with whether the user is right-handed or left-handed.

5. The information processing apparatus according to claim 1, wherein the predetermined gesture is a gesture performed along a direction slant with respect to a predetermined horizontal direction and a predetermined vertical direction on the touch panel.

6. The information processing apparatus according to claim 1, wherein a travel distance per unit time of the predetermined gesture from its beginning to its end is larger than a predetermined value.

7. The information processing apparatus according to claim 1, wherein the predetermined gesture is completed within a predetermined time period, and a travel distance of the predetermined gesture is larger than a predetermined value.

8. The information processing apparatus according to claim 1, further comprising:
an aborting unit that aborts, if a plurality of abortable operations are present on the information processing apparatus, an abortable operation selected from the list in response to selection of the abortable operation by the user, and aborts, if only one abortable operation is present on the information processing apparatus, the only one abortable operation in response to detection of the predetermined move operation regardless of selection of the only one abortable operation by the user.

9. The information processing apparatus according to claim 1, further comprising:
an aborting unit that aborts an abortable operation selected from the list of abortable operations by the user,
wherein, if a predetermined operation is abortable on the information processing apparatus, the aborting unit aborts the predetermined operation in response to detection of the predetermined gesture regardless of selection of the predetermined operation by the user.

10. The information processing apparatus according to claim 9, wherein the predetermined operation is transmission of data from the information processing apparatus to another apparatus.

11. A non-transitory computer readable medium storing a program causing a computer to execute a process for processing information, the process comprising:
detecting a gesture performed on a touch panel by a user; and
outputting data used to display a list of abortable operations on the computer in response to detection of a predetermined gesture performed in contact with the touch panel, the predetermined gesture being a movement that involves a change in point of contact with the touch panel.
